(19) United States
(12) Patent Application Publication
(10) Pub. No.: US 2008/0053794 A1
(43) Pub. Date: Mar. 6, 2008

(54) Conveyor transfer system

(76) Inventors: Michael D. Brain, Monte Sereno, CA (US); Barry Kitazumi, Milpitas, CA (US); Mihir Parikh, Los Altos Hills, CA (US); Brian Compian, Cupertino, CA (US)

Correspondence Address: CARR & FERRELL LLP, 2200 GENG ROAD, PALO ALTO, CA, 94303, US

(21) Appl. No.: 11/897,013

(22) Filed: Aug. 27, 2007

Related U.S. Application Data
(60) Provisional application No. 60/840,131, filed on Aug. 25, 2006.

(51) Int. Cl. B65G 15/00

(52) U.S. Cl. 198/626.1; 414/935

(57) ABSTRACT

A transport system for conveying articles along conveyance paths including straight, curvilinear, horizontal, vertical, inclined, and declined conveyance sections optionally physically offset from one another horizontally, vertically, or combinations thereof. The articles are conveyed between a pair of transport belts or rollers and/or by conveyance elements such as a gripper, a robotic hoist, a lift, or an elevator while being optionally supported by protrusions extending from the belts or rollers, secured via a kinematic interface, grasped by a gripper, or supported by air bearings. Multiple conveyance sections, lifts, robotic hoists, grippers, and elevators can be joined, interfaced, and/or integrated over complex paths and arrangements with one another as well as with manufacturing, processing, measurement, and sorting equipment. The articles conveyed may include semiconductor wafers, substrates for the manufacture of display devices or photovoltaics, or the like.

### CROSS-REFERENCE TO RELATED APPLICATIONS

This application claims the benefit of U.S. Provisional Application No. 60/840,131 entitled “High Speed Transfers Between Transport Devices” and filed on Aug. 25, 2006, which is incorporated by reference herein. This application is related to U.S. application Ser. No. 11/406,569 entitled “Transport System Including Vertical Rollers” and filed on Apr. 18, 2006; U.S. application Ser. No. 11/764,161 entitled “Transport System Including Vertical Rollers” and filed on Jun. 15, 2007; U.S. application Ser. No. 11/764,755 entitled “Conveyor System Including Offset Section” and filed on Jun. 18, 2007; and U.S. application Ser. No. 11/818,657 entitled “Systems and Methods for Transport Through Curves” and filed on Jun. 14, 2007. The disclosures of each of the aforementioned applications are incorporated herein by reference.

### BACKGROUND OF THE INVENTION

1. Field of the Invention

The current invention relates to transport systems and methods for conveying articles along a conveyance path, and in some embodiments to conveying semiconductor wafers in a semiconductor fabrication facility.

2. Related Art

Transport systems are widely employed in industrial manufacturing facilities to convey articles between work stations. Originally, these systems were manual and workers moved articles by hand or by cart. Modern factories have developed specialized equipment to convey articles automatically. In particular, semiconductor fabrication facilities currently use automated transport systems to move semiconductor wafers during the manufacturing process. Typically, a batch of wafers may be conveyed together in a container known as a Front Opening Unified Pod (FOUP). Semiconductor wafer manufacturers have sought to increase manufacturing productivity by using transport systems that efficiently convey wafers from machine to machine without exposing the wafers to excessive contamination, to excessive vibration, or to excessive acceleration and deceleration forces.

Existing transport systems employ vehicle-based devices to grasp a FOUP using a top handle and move the FOUP from one location to another location. For example, a vehicle may be used to grasp a FOUP, raise the FOUP to a higher level, move the FOUP to a new position above a destination, lower the FOUP onto the destination, and then release the FOUP. After the vehicle has released the FOUP, the vehicle may then be dispatched to a location of a next FOUP requiring similar movement. While the vehicle is transporting the FOUP, the vehicle is considered loaded. After the vehicle has released the FOUP and before the vehicle grasps the next FOUP, it is considered empty. A period of time during which the vehicle is empty, for example the period of time during which the empty vehicle moves from the location where the vehicle released the first FOUP to the location where the vehicle grasps the next FOUP, increases the overall time required for delivery of FOUPs to their destinations. The period of time the vehicle is empty may lead to a bottleneck and cause traffic congestion in a fabrication facility due to an inefficient use of resources.

There are, therefore, needs for improved systems and methods for conveying in manufacturing facilities.

### SUMMARY OF THE INVENTION

In a semiconductor fabrication facility, it is desirable to transport material at very high speeds throughout the fabrication facility and then quickly deliver the material onto process and metrology equipment. The material is typically transported inside a carrier called a FOUP. The FOUP can be transported on a transport system such as those disclosed in U.S. patent application Ser. Nos. 11/406,569, 11/764,161, 11/764,755, and 11/818,657. In these applications, systems are disclosed that can move a FOUP at speeds higher than systems of the prior art. The FOUP is typically supported by a moving transport belt from below the FOUP.

The present invention includes, in various embodiments, a transport system for transferring articles that are moving along a conveyance path from one source location, conveyance section, processing tool, storage location, or the like to a destination location, conveyance section, processing tool, storage location, or the like. The articles may be moved in any combination of directions in three dimensions, including up, down, north, south, east, or west. The conveyance path along which the article is transported may include straight, curvilinear, horizontal, inclined and/or declined sections.

The present invention includes, in various embodiments, a system comprising a first conveyance section comprising a first transport belt and a second transport belt disposed on either side of a conveyance path. The first conveyance section is configured to convey a FOUP along the conveyance path. The first transport belt and the second transport belt are separated by a distance configured for placement of the FOUP between the first transport belt and the second transport belt. Further, the system includes a lift configured to lift the FOUP from the first transport belt and the second transport belt. The lift is further configured to rotate the FOUP such that the FOUP can pass between the first transport belt and the second transport belt along a vertical axis.

The present invention includes, in various embodiments, a system comprising a first conveyance section including a first transport belt and a second transport belt disposed on either side of a conveyance path. The first conveyance section is configured to convey a FOUP along the conveyance path. The first transport belt and the second transport belt are separated by a distance configured for placement of the FOUP between the first transport belt and the second transport belt. The first conveyance section is disposed at a first height. Additionally, the system comprises an elevator including a first elevator belt and a second elevator belt. The elevator is configured to lift the FOUP from the first conveyance section. The elevator is further configured move the FOUP to a second conveyance section at a second height.

The present invention includes, in various embodiments, a system comprising a first conveyance section including a first transport belt and a second transport belt disposed on either side of a conveyance path. The first conveyance section is configured to convey a FOUP along the conveyance path. The first transport belt and the second transport belt are separated by a distance configured for placement of the FOUP between the first transport belt and the second transport belt. The first conveyance section is disposed at a first height. Furthermore, the system comprises an overhead gripper including a first gripper belt and a second gripper belt. The first gripper belt and the second gripper belt are configured to grip a top handle of the FOUP. The overhead gripper is further configured to raise the FOUP from the first height to a second height.

The present invention includes, in various embodiments, a system comprising a turntable. The turntable includes a first transport belt and a second transport belt disposed on either side of a conveyance path. The first transport belt and the second transport belt are separated by a distance configured for placement of the FOUP between the first transport belt and the second transport belt. The turntable is configured to receive a FOUP from a first location at a first angle relative to a central vertical axis between the first transport belt and the second transport belt. The turntable is further configured to convey the FOUP along the conveyance path, rotate the FOUP about the vertical axis, and deliver the FOUP to a second location at a second angle relative to the central vertical axis.

### BRIEF DESCRIPTION OF THE DRAWINGS

For a more complete understanding of the present invention and for further features and advantages, reference is made to the following description taken in conjunction with the accompanying drawings, in which:

FIG. 1 is a perspective view of a conveyance section according to various embodiments of the invention;

FIG. 2A illustrates a conveyance section comprising a lift including a kinematic interface, according to various embodiments of the invention;

FIG. 2B illustrates the conveyance section in which the lift rotates a FOUP in a direction of rotation;

FIG. 2C illustrates the conveyance section 200 after the lift has rotated the FOUP by approximately 90 degrees;

FIG. 3 illustrates a top view of a FOUP indicating typical dimensions, according to various embodiments of the invention;

FIG. 4 Illustrates a method of using the lift as shown in FIGS. 2A, 2B, and 2C to lower the FOUP from the conveyance section to another location, according to various embodiments of the invention;

FIGS. 5A, 5B, 5C, and 5D illustrate a side view of the conveyance sections shown in FIGS. 2A, 2B, and 2C at various steps of the method illustrated in FIG. 4, according to various embodiments of the invention;

FIGS. 6A and 6B illustrate a transfer system comprising a conveyance section, a robotic hoist, and machine load ports, according to various embodiments of the invention;

FIGS. 7A, 7B, 7C, 7D, and 7E illustrate cross-sectional views of a transfer system comprising two conveyance sections, rotatable rails, a lift, and a FOUP in different states of transfer, according to various embodiments of the invention;

FIG. 8 illustrates a transport section comprising a conveyance section and an overhead gripper system, according to various embodiments of the invention;

FIG. 9 illustrates a transport section comprising a conveyance section in conjunction with overhead gripper belts, according to various embodiments of the invention;

FIG. 10 illustrates a transport system comprising an overhead gripper ramp in conjunction with a conveyance section, according to various embodiments of the invention;

FIG. 11 illustrates a profile view of the gripper belts, according to various embodiments of the invention;

FIGS. 12A and 12B illustrate a transport system comprising several conveyance sections and a turnstile, according to various embodiments of the invention;

FIG. 13 illustrates a method of using the transport system illustrated in FIGS. 12A and 12B to transfer a FOUP to and from a machine load port, according to various embodiments of the invention;

FIG. 14 illustrates a vertical conveyance section or elevator, according to various embodiments of the invention;

FIG. 15 illustrates a transport system comprising several conveyance sections and an elevator as illustrated in FIG. 14;

FIG. 16 illustrates a method of transferring an article in a vertical direction using the elevator as illustrated in FIGS. 14 and 15;

FIG. 17 illustrates a transport section comprising a first transport belt 110 and a second transport belt 120, the transport section being configured to provide air bearings along a conveyance path between the first transport belt 110 and the second transport belt 120; and

FIGS. 18A, 18B, and 18C illustrate air bearing generators configured to generate the air bearings illustrated in FIG. 17.

FIG. 19 shows a bottom view of a FOUP including valves for purging the interior thereof.

### DETAILED DESCRIPTION OF THE INVENTION

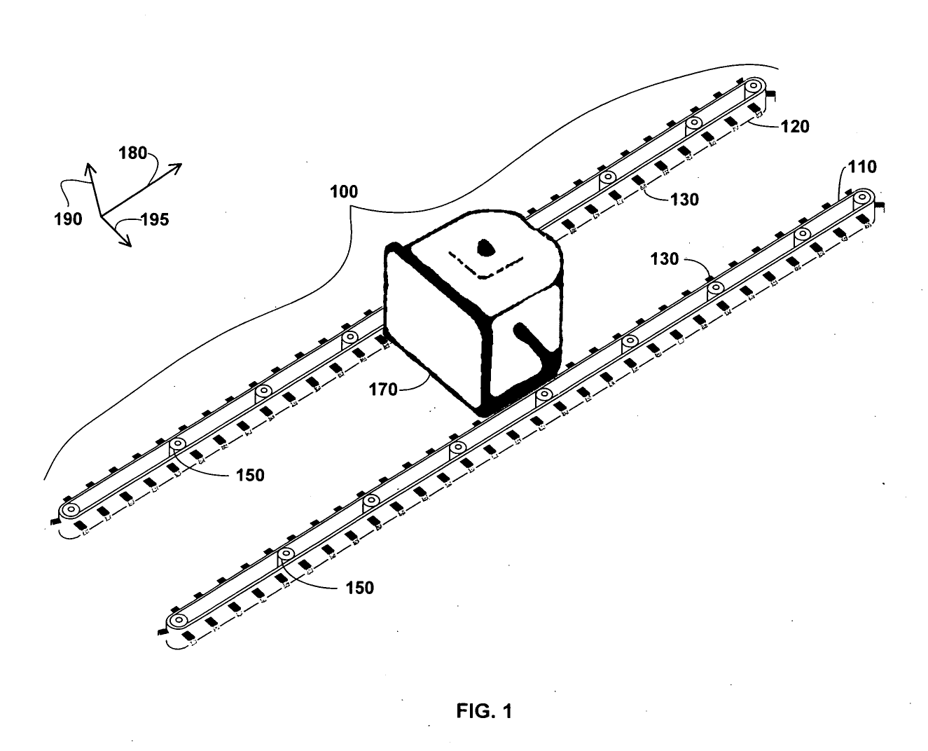

FIG. 1 is a perspective view of a conveyance section 100 according to various embodiments of the invention. The conveyance section 100 comprises a first transport belt 110, a second transport belt 120, a plurality of rollers 150, and optional support protrusions 130. The plurality of rollers 150 are configured to guide and optionally support the first transport belt 110 and the second transport belt 120. The support protrusions are typically coupled with the first transport belt 110 and the second transport belt 120 and configured to support an article such as a FOUP 170. In various embodiments, the first transport belt 110 and/or the second transport belt 120 may be vertically oriented, horizontally oriented, or slanted between horizontal and vertical. In some embodiments, at least some portion of the first transport belt 110 and/or the second transport belt 120 may be substituted with alternative support members such as rollers. In these embodiments, support protrusions may also optionally be coupled with the alternative support members and configured to support an article such as a FOUP 170.

The conveyance section 100 is configured to convey the FOUP 170 in a conveyance direction 180 along a conveyance path between the first transport belt 110 and the second transport belt 120. The conveyance section 100 may be configured with multiple instances of conveyance sections 100.

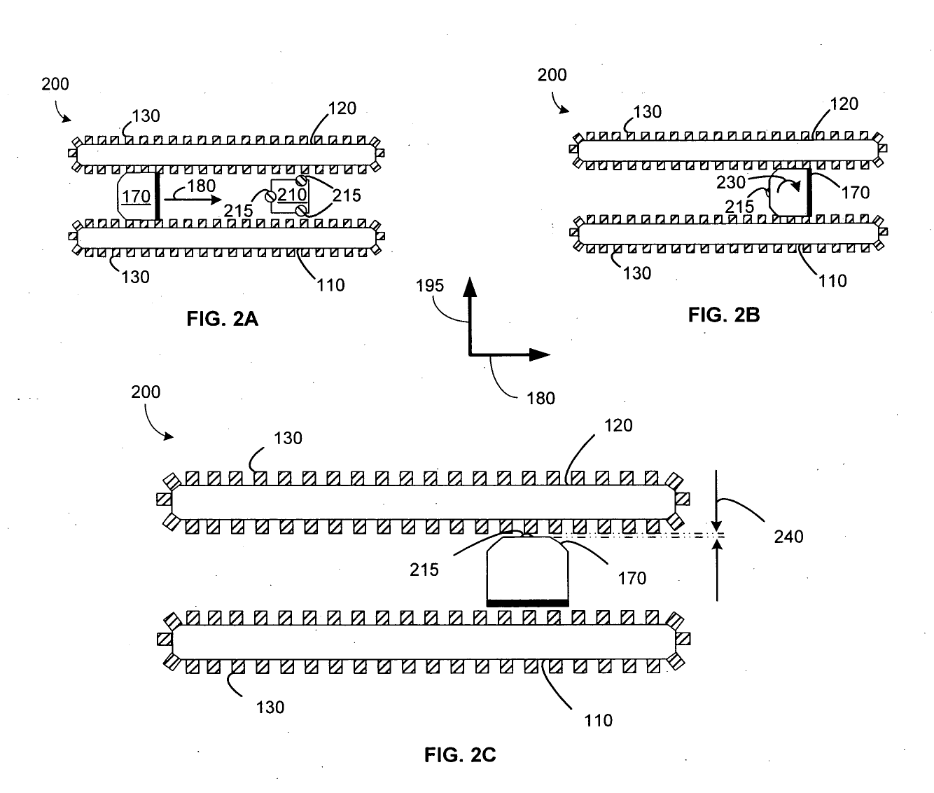

FIG. 2A illustrates a conveyance section 200 comprising a first transport belt 110, a second transport belt 120, a plurality of optional support protrusions 130, and a lift 210. In various embodiments, the conveyance section 200 may comprise any embodiment of the conveyance section 100 further comprising the lift 210. The lift 210 is configured to include a kinematic interface, according to various embodiments of the invention. The lift 210 may be disposed between the transport belts 110 and 120 such that the lift 210 can be raised and lowered along a vertical axis 190 under the FOUP 170 when the FOUP 170 is disposed in a location above the lift 210. In some embodiments, the lift 210 may be configured to raise the FOUP 170 above a horizontal plane of the transport belts 110 and 120 within the conveyance section 200. In other embodiments, the lift 210 may be configured to lower the FOUP 170 below the horizontal plane of the transport belts 110 and 120 within the conveyance section 200. In still other embodiments, the lift 210 may be configured to both raise and lower the FOUP 170 above and below the horizontal plane of the transport belts 110 and 120 within the conveyance section 200.

FIG. 2B illustrates the conveyance section 200 in which the lift 210 rotates the FOUP 170 in a direction of rotation 230. As the conveyance section 200 moves the FOUP 170 proximate to the lift 210, the conveyance section optionally stops the FOUP 170 in a position approximately over the lift 210. Interface features, such as kinematic coupling pins 215 disposed on a top surface of the lift 210, may optionally interact and couple with corresponding interface features on a bottom surface of the FOUP 170, such as three kinematic holes. The kinematic coupling pins 215 and related features are configured to support proper alignment between the FOUP 170 and the lift 210. After the FOUP 170 is aligned and coupled with the lift 210, the lift 210 may be used to lift the FOUP 170 above a surface of the transport belts 110 and 120 and/or support protrusions 130. Once the FOUP 170 is above and no longer in substantial contact with the transport belts 110 and 120 and/or the support protrusions 130, the lift 210 may rotate the FOUP 170 freely in a rotational direction 230 along a horizontal plane. In some embodiments, the lift 210 may rotate in a rotational direction opposite the rotational direction 230. The lift 210 may rotate the FOUP 170 by approximately a positive or negative 90 degrees, 180 degrees, 270 degrees, or 360 degrees. FIG. 2C illustrates the conveyance section 200 after the lift 210 has rotated the FOUP 170 by approximately 90 degrees.

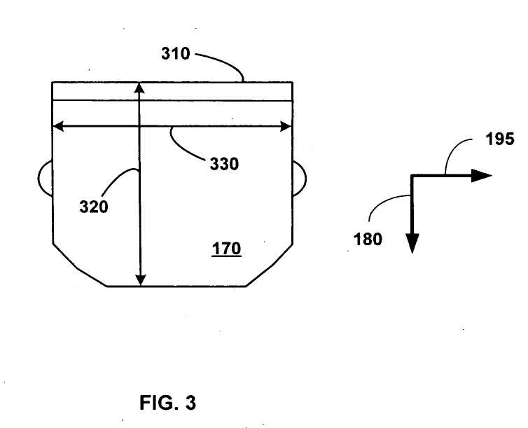

As illustrated in FIG. 3, the FOUP 170 is characterized by a longer width 330 parallel to the FOUP door 310 relative to a length 320 perpendicular to the FOUP door 310. For example, in various embodiments, the width 330 may be approximately 390 mm, and the length 320 may be approximately 356 mm. The spacing between transport belts 110 and 120 is typically configured to support the FOUP 170 when the FOUP 170 is oriented such that the width 330 and FOUP door 310 are perpendicular to the transport belts 110 and 120 along the horizontal axis 195. Therefore, when the lift 210 rotates that FOUP 170 in approximately a multiple of ninety degrees, the smaller FOUP length 320 will be perpendicular to the transport belts 110 and 120 along the horizontal axis 195. When the FOUP 170 is oriented in this manner, the conveyance section 200 is configured to provide a clearance 240 (FIG. 2C) between the FOUP 170 and the support protrusions 130 of the transport belts 110 and 120. The clearance 240 enables the lift 210 to lower the FOUP 170 down between the transport belts 110 and 120 without contacting the transport belts 110 and 120 or the support protrusions 130. The lift 210 may be configured to lower the FOUP 170 below the horizontal plane of the transport belts 110 and 120 by any amount as needed to deliver the FOUP 170 to its next destination. Once the FOUP 170 has been lowered below the horizontal plane of the transport belts 110 and 120, the FOUP 170 may be rotated by any arbitrary amount as appropriate or necessary to align the FOUP 170 with another conveyance section 200 or other destination, or held in place.

Because the clearance 240 is not required for the lift 210 to raise the FOUP 170 above a horizontal plane of the transport belts 110 and 120, the lift 210 is not required to rotate the FOUP 170 before raising the FOUP 170 along the vertical axis 190. Furthermore, the lift 210 may rotate the FOUP 170 by any arbitrary amount before, during, or after raising the FOUP 170 along the vertical axis 190 as appropriate or necessary to align the FOUP 170 with another conveyance section 200 or other destination.

In various embodiments, specific mechanical, electrical, and software interfaces are defined to enable a variety of devices to directly access the FOUP 170 disposed on the transport belts 110 and 120. Embodiments of such interfaces include a mechanical interface such as the kinematic interface defined by the trade organization SEMI in the document number E57-0600 entitled “Mechanical Specification for Kinematic Couplings used to Align and Support 300 mm Wafer Carriers” and the electrical interface and software communications interface defined by the SEMI standard E84-0305 entitled “Specification for Enhanced Carrier Handoff Parallel I/O Interface.” The kinematic interface features three kinematic coupling pins on a kinematic mount, the kinematic coupling pins being configured to mate with three corresponding depressions disposed on the bottom of the FOUP 170 when the FOUP 170 is placed in proper alignment with the kinematic mount.

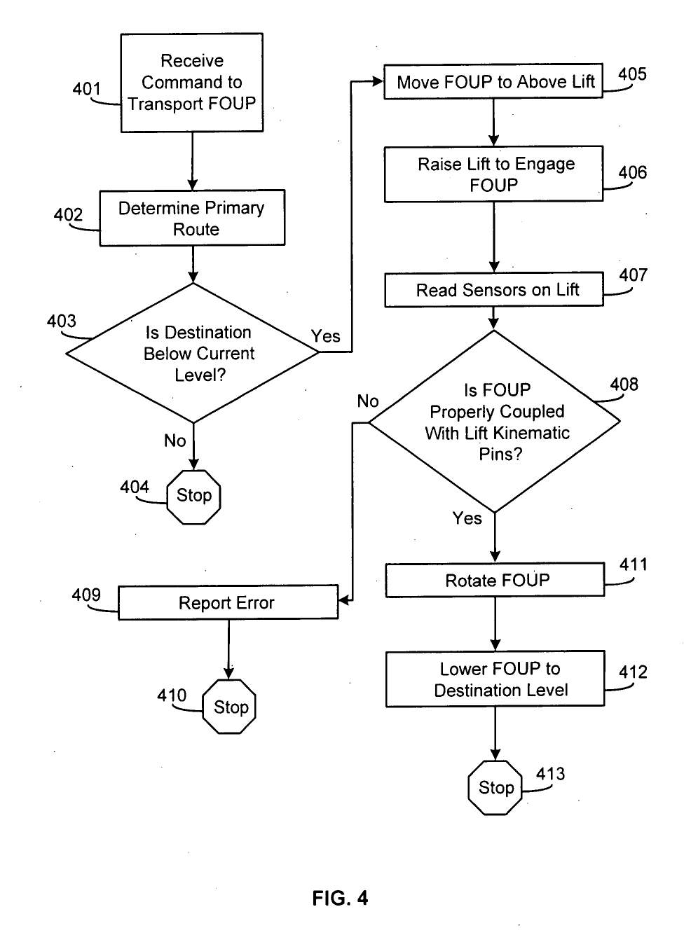

FIG. 4 illustrates a method of using the lift 210 as shown in FIGS. 2A, 2B, and 2C to lower the FOUP 170 from the conveyance section 200 to another location, according to various embodiments of the invention. The method may be implemented using a combination of computer systems comprising both hardware and software coupled with the conveyance section 200. The method is employed when a FOUP 170 is supported by a pair of transport belts 110 and 120 above a lift 210.

In step 401, a command to transport FOUP 170 to a destination is received. The command may be first determined and transmitted by a computer system and/or operator configured to control the movement of FOUPs 170 throughout a transport system comprising a plurality of conveyance sections 200 and other related transport devices. The destination is typically a location within the transport system, and may be proximate a lift 210 or a conveyance section 200.

In step 402, a primary route between the current location of the FOUP 170 and the destination is determined.

In step 403, a determination is made regarding whether the destination is below the transport belts 110 and 120. If the destination is determined to not be below the transport belts 110 and 120, the method ends at a step 404, and the lift 210 is not utilized. If the destination is determined to be below the transport belts 110 and 120 in step 403, then step 405 is performed.

In step 405, the transport belts 110 and 120 are used to convey the FOUP 170 along the route to the lift 210 as illustrated in FIG. 1. Step 405 ends when the FOUP 170 is located directly above the lift 210, at which time step 406 is executed.

In step 406, the lift 210 is raised to couple with the FOUP 170. After step 406 is completed, step 407 may optionally be performed.

In optional step 407, an output of a sensor disposed on lift 210 is read in order to assure that FOUP 170 is properly coupled with lift 210.

In optional step 408, the output of the sensor-read in step 407 is evaluated to determine whether the FOUP 170 is properly coupled with the kinematic coupling pins 215 on the lift 210. If the evaluation indicates that the FOUP 170 is not properly coupled with the lift 210, then step 409 is performed. Otherwise, step 411 is performed.

In optional step 409, an error is reported. Following the reporting of the error, the method is stopped at step 410.

In step 411, the lift 210 rotates the FOUP 170 by approximately a multiple of 90 degrees.

In step 412, the lift 210 lowers the FOUP 170 along a vertical axis 190 to a destination level of the intended destination. At the conclusions of step 412, the method ends at step 413.

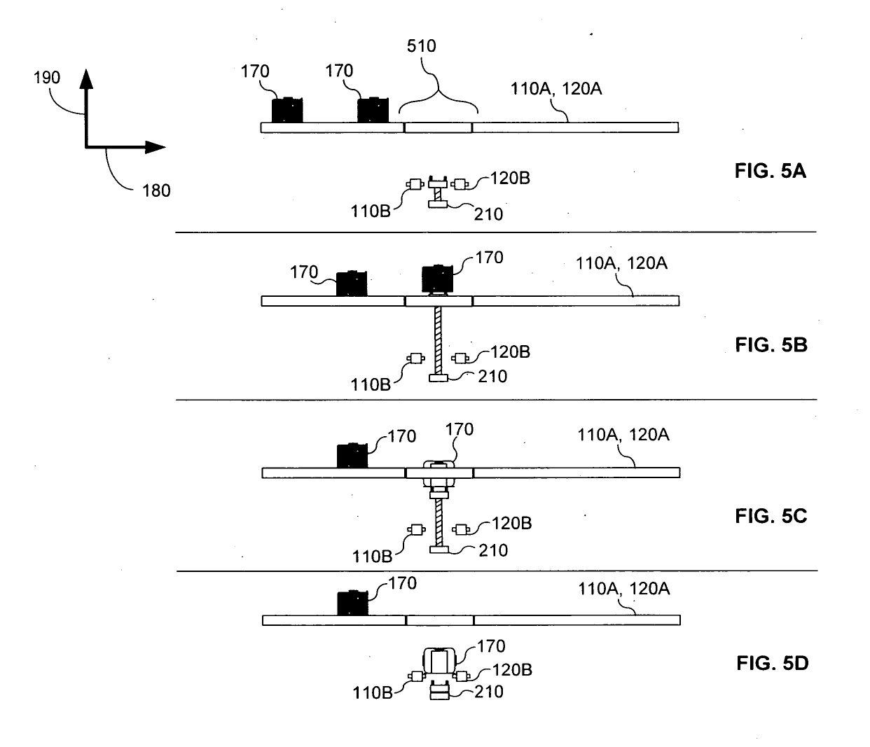

FIGS. 5A, 5B, 5C, and 5D illustrate a side view of the conveyance sections 200 shown in FIGS. 2A, 2B, and 2C at various steps of the method illustrated in FIG. 4, according to various embodiments of the invention. In these embodiments, the lift 210 lowers the FOUP 170 along a vertical axis 190 from a first set of transport belts 110A and 120A to a second set of transport belts 110B and 120B. The second set of transport belts 111B and 120B may be configured to transport the FOUP 170 in any desired direction. As illustrated in FIGS. 5A, 5B, 5C, and 5D, the second set of transport belts 110B and 120B are configured to transport the FOUP 170 in a direction approximately 90 degrees from the conveyance direction 180 of the first set of transport belts 110A and 120A. Using the lift 210, an intersection 510 between the first set of transport belts 110A and 120A and the second set of transport belts 110B and 120B can be created without physically interfering or modifying either the first set of transport belts 110A and 120A and the second set of transport belts 110B and 120B. Therefore, neither the first set of transport belts 110A and 120A nor the second set of transport belts 110B and 120B need to begin or end a conveyance section 200 at any specific point. The intersection 510 may be located anywhere along a length of a conveyance section 200, such as towards the middle or near either end. Flexibility in placement of the intersection 510 along a conveyance section 200 allows conveyance sections 200 to be deployed and relocated without being configured as having specific lengths.

As illustrated in FIG. 5A, the FOUP 170 is conveyed along transport belts 110A and 120A toward the intersection 510. As illustrated in FIG. 5B, the FOUP 170 is disposed at the intersection 510 where the lift 210 is configured to move along a vertical axis 190 between the first set of transport belts 110A and 120A and the second set of transport belts 110B and 120B. The lift 210 is used to lift the FOUP 170 from the first set of transport belts 110A and 120A. As illustrated in FIG. 5C, the FOUP 170 is rotated approximately 90 degrees and the lift 210 lowers the FOUP 170 through a space between the first set of transport belts 110A and 120A. Once below a horizontal plane of the transport belts 110A and 120A, the lift 210 optionally rotates the FOUP 170 by an angle defined as the angle between the conveyance direction 180 of the first set of transport belts 110A and 120A and a conveyance direction of the second sets of transport belts 110B and 120B. Once properly oriented, the FOUP 170 may be lowered onto the second set of transport belts 110B and 120B as illustrated in FIG. 5D. The second set of transport belts 110B and 120B may transport the FOUP 170 in a new conveyance direction.

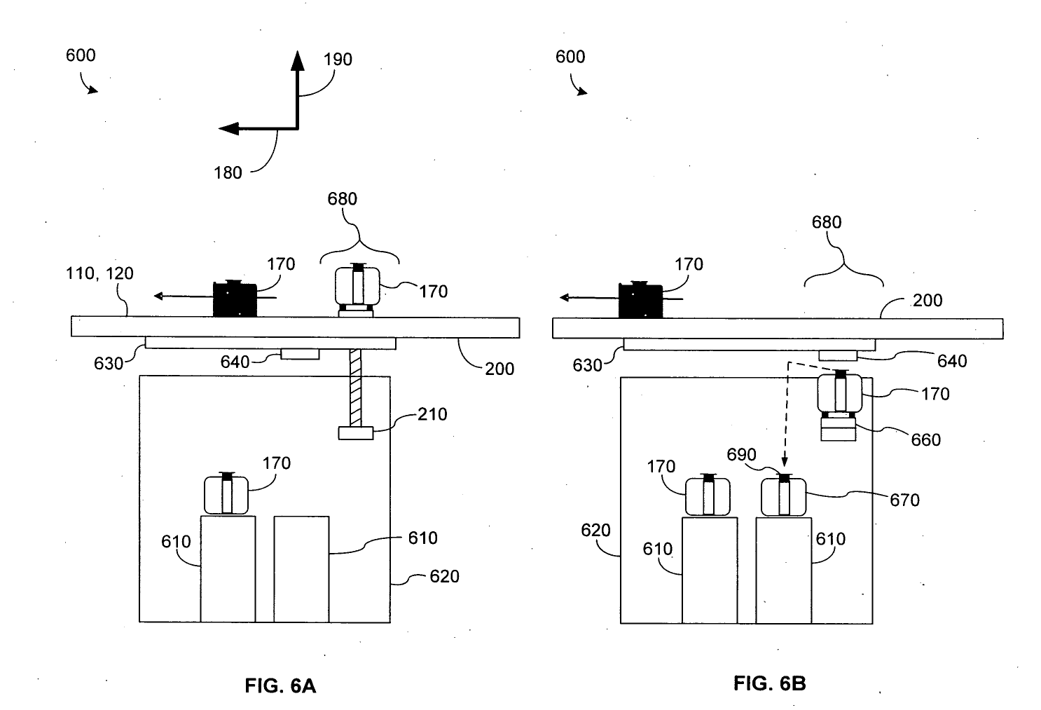

FIGS. 6A and 6B illustrate a transfer system 600 comprising a conveyance section 200, a robotic hoist 630, and machine load ports 610, according to various embodiments of the invention. After a conveyance section 200 conveys a FOUP 170 via transport belts 110 and 120 to an equipment transfer location 680 near the location of a destination process or metrology equipment 620, the transfer system 600 may transfer the FOUP 170 onto the equipment for processing or metrology. In some embodiments, the conveyance section 200 comprising transport belts 110 and 120 may be disposed above the process or metrology equipment 620. The lift 210 may lift the FOUP 170 from the transport belts 110 and 120, rotate the FOUP 170, and then lower the FOUP 170 to an intermediate location 660 as shown in FIG. 6B. The destination processing or metrology equipment 620 may be configured to access the FOUP 170 while the FOUP 170 is located at the intermediate location 660, open the FOUP front door 310, and process or perform measurements of the contents such as semiconductor wafers disposed within the FOUP 170.

Alternatively, when the processing or metrology equipment 620 is ready to receive the FOUP 170, the transfer system 600 may transfer the FOUP 170 from the intermediate location 660 onto an equipment load port 610 using a device such as a robotic hoist 630 comprising a gripper 640. The robotic hoist 630 may be configured to use the gripper 640 to grasp a top handle disposed on a top surface of the FOUP 170, lift the FOUP 170 from the lift 210 at the intermediate location 660, move the gripper 640 horizontally until the gripper 640 is over the destination equipment load port 610, lower the FOUP 170 along a vertical axis 190 until the FOUP 170 rests on or couples with the equipment load port 610, and release the FOUP 170.

In various embodiments, the robotic hoist 630 is integrated with the conveyance section 200 comprising the transport belts 110 and 120. Integration of the robotic hoist 630 with the conveyance section 200 reduces mis-alignment between the gripper 640, the intermediate location 660, and the load ports 610. In addition, the robotic hoist 630 may be configured to share a common power and communications infrastructure as well as mechanical and seismic supports with the conveyance section 200.

In some embodiments, the lift 210 may be integrated with a load port of the processing or metrology equipment 620. In these embodiments, the lift 210 may also be integrated with a load port FOUP front door opening device. Such integration between the equipment load port and the lift 210 of the transfer system 600 eliminates intermediate steps and mechanisms. The lift 210 integrated with the load port 610 may be configured to transfer the FOUP 170 directly from the transport belts 110 and 120 to a machine load port location 670 at a load port 610. After the FOUP 170 is transferred to the machine load port location 670, the equipment may open the FOUP door and access material such as semiconductor wafers located within the FOUP 170.

In various embodiments, the transfer system 600 is configured to transfer a FOUP 170 from the transport belts 110 and 120 to the processing or metrology equipment 620 without stopping the motion of the FOUP 170 on the transport belts 110 and 120. The lift 210 with the kinematic interface may be configured with an additional axis of motion such that the lift 210 may be moved horizontally along the conveyance direction 180 in synchronization with the movement of the FOUP 170 along the transport belts 110 and 120 in the conveyance direction 180. When the position along a vertical axis 190 and speed along the conveyance direction 180 of the kinematic lift 210 and the FOUP 170 is about equal, the lift 210 may be raised to couple with the FOUP 170, lift the FOUP 170, rotate the FOUP 170, and lower the FOUP 170. The kinematic lift 210 may then move the FOUP 170 in both horizontal and vertical directions to position the FOUP 170 at the destination load port 610. The kinematic lift 210 that is configured to move along the horizontal conveyance direction 180 as well as raise and lower along a vertical axis 190 enables the transport belts 110 and 120 to maintain their full speed when the FOUP 170 is removed from or placed on the transport belts 110 and 120. In some embodiments, the transport belts 110 and 120 may be slowed down when a FOUP 170 is loaded or unloaded to assure that no collision occurs between the FOUP 170 being loaded or unloaded from transport belts 110 and 120 and other FOUPs 170 being transported on the same transport belts 110 and 120.

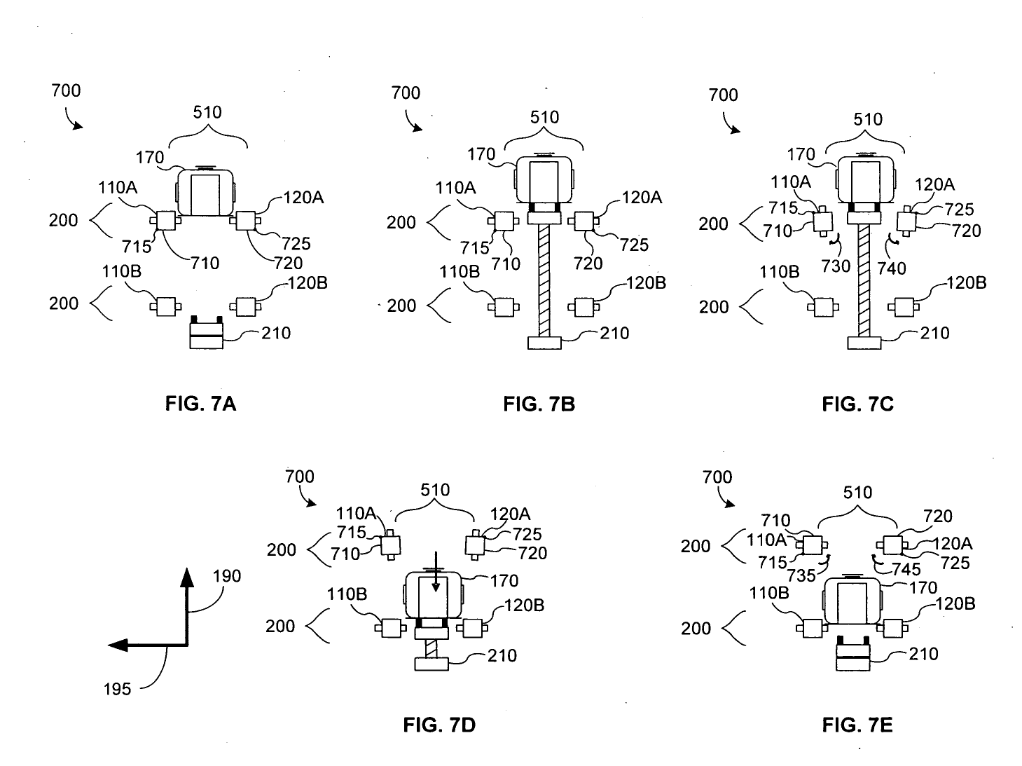

FIGS. 7A, 7B, 7C, 7D, and 7E illustrate cross-sectional views of a transfer system 700 comprising two conveyance sections 200, rotatable rails 710 and 720, a lift 210, and a FOUP 170 in different states of transfer, according to various embodiments of the invention. In some embodiments, additional clearance is required to lower the FOUP 170 between the transport belts 110A and 120A. In these embodiments, the transport belts 110A and 120A are optionally mounted on rotatable rails 710 and 720, respectively, so that the transport belts 110A and 120A can be rotated about an axis at the outside of their lateral dimension, such as axes 715 and 725, respectively. As illustrated in FIG. 7A, the FOUP 170 is supported by the transport belts 110A and 120A at an intersection 510 above a lift 210. As illustrated in FIG. 7B, the lift 210 lifts the FOUP 170 from the transport belts 110A and 120A. As illustrated in FIG. 7C, the rotatable rail 710 coupled with the transport belt 110A is rotated away from the FOUP 170 about the axis 715 in a direction of rotation 730 and the rotatable rail 725 coupled with the transport belt 120A is rotated away from the FOUP 170 about the axis 725 in a direction of rotation 740 such that the support protrusions 130 are no longer oriented along a horizontal axis in the horizontal plane of the conveyance section 200. The rotation of the rotatable rails increases the open space between the transport belts 110A and 120A. As illustrated in FIG. 7D, using this additional space, the lift 210 can lower the FOUP 170 from above the transport belts 110A and 120A, through the open space between them down to another conveyance section 200 comprising transport belts 110B and 120B. The additional open space between the transport belts 110A and 120A provided by the rotatable rails 710 and 720 decreases the possibility of interference between the FOUP 170 and the transport belts 110A and 120A. As illustrated in FIG. 7E, after the lift 210 has lowered the FOUP 170 from the transport belts 110A and 120A to the transport belts 110B and 120B, the rotatable rails 710 and 720 are rotated back to their original positions as previously illustrated in FIGS. 7A and 7B. In an alternative embodiment, rather than using rotatable rails, the conveyance section 200 may be configured to shift the horizontal position of the transport belts 110A and 120A along the horizontal axis 195 away from another, by a sufficient amount, such as a few centimeters, to allow sufficient clearance for the lift 210 to lower the FOUP 170 through the space between the transport belt 110A and the transport belt 120A.

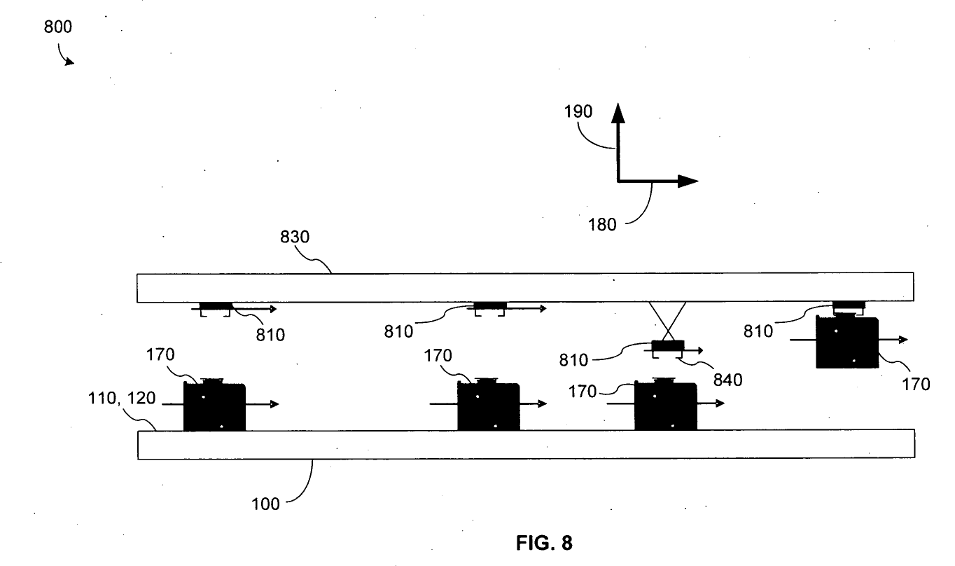

FIG. 8 illustrates a transport section 800 comprising a conveyance section 100 and an overhead gripper system 830, according to various embodiments of the invention. The conveyance section 100, further comprising transport belts 110 and 120, is configured to convey a FOUP 170 along a conveyance direction 180 below the overhead gripper system 830. The overhead gripper system 830 is configured to support and move an overhead gripper 810 in a horizontal direction along the conveyance direction 180 in parallel with the conveyance direction 180 of the conveyance section 100. The gripper 810 may be configured to allow some flexibility and increase reliability of the FOUP 170 transfer. For example, the gripper 810 may be configured to include a simple device with fingers, such as gripper fingers 840, to actively grasp the FOUP 170 top handle such as is commonly used by hoists to handle FOUPs in a production environment. This grasping action can occur while FOUP 170 is moving along transport belts 110 and 120.

The overhead gripper system 830 is configured to lower the gripper 810 toward the FOUP 170, grasp a top handle of the FOUP 170 using gripper fingers 840, and lift the FOUP 170 off the transport belts 110 and 120. The gripper system 830 may be configured to grasp and lift the FOUP 170 as it travels along the conveyance direction 180 on the transport belts 110 and 120 without requiring the transport belts 110 and 120 to slow down or stop. The gripper system 830 may cause the speed of the gripper 810 along the conveyance direction 180 to match the speed of the FOUP 170 on the transport belts 110 and 120 along the conveyance direction 180. When the speed is matched, the gripper 810 is lowered into place on the top handle of the FOUP 170 until the gripper fingers 840 can grasp the FOUP 170. Once the FOUP 170 is securely held by the gripper fingers 840, the gripper 810 may lift the FOUP 170 from the transport belts 110 and 120 and transfer the FOUP 170 to a variety of locations such as a buffer location, an equipment load port, or another section of transport belt in another location, altitude, or orientation. In some embodiments, the transport belts 110 and 120 may be significantly slowed or stopped prior to the gripper system 830 positioning the gripper 810 above the FOUP 170, lowering the gripper 810 onto the top handle of the FOUP 170, grasping the FOUP 170 using the gripper fingers 840, and lifting the FOUP 170 off the transport belts 110 and 120.

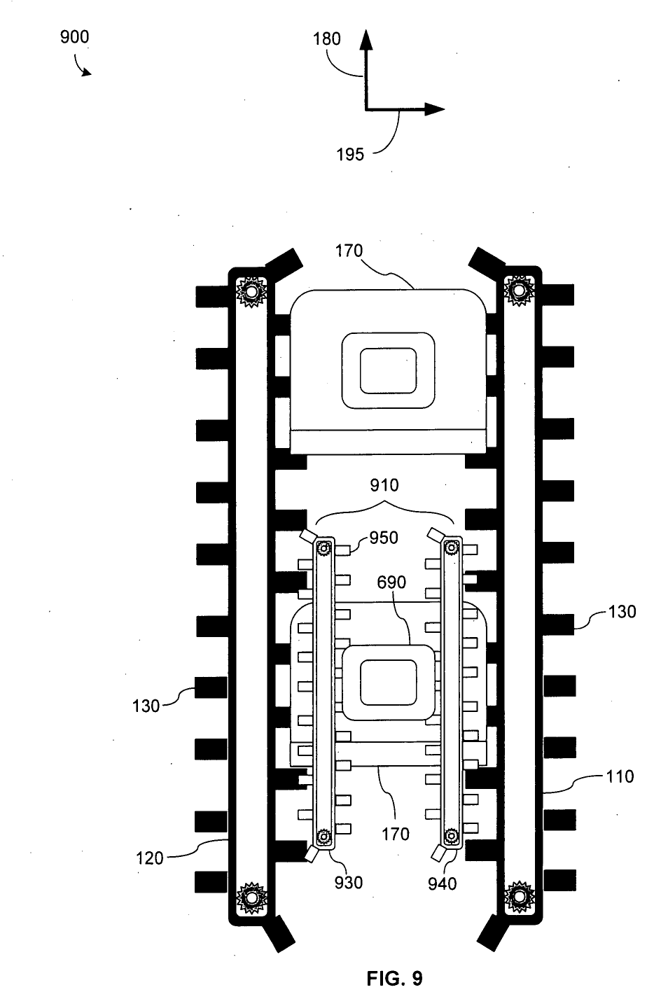

FIG. 9 illustrates a top profile of a transport section 900 comprising a conveyance section 100 in conjunction with overhead gripper belts 930 and 940, according to various embodiments of the invention. In these embodiments, an overhead gripper system 910 comprises a pair of gripper belts 930 and 940 with features designed to engage a top handle 690 of the FOUP 170. The gripper belts 930 and 940 may be substantially vertical belts, horizontal belts, or slanted belts oriented between horizontally and vertically. As illustrated in FIG. 9, the transport belts 110 and 120 are conveying the FOUP 170 in a conveyance direction 180 while being supported by support protrusions 130. Two gripper belts 930 and 940 may be positioned line with the top handle 690 of the FOUP 170. The speed of the transport belts 110 and 120 and the gripper belts 930 and 940 may be sufficiently matched such that the gripper belts 930 and 940 may engage the top handle 690 of the FOUP 170 without significant relative motion between the top handle 690 of the FOUP 170 and the gripper belts 930 and 940. Alternatively, the gripper belts 930 and 940 may be configured to reduce relative motion between the top handle 690 of the FOUP 170 and the gripper belts 930 and 940 by enabling a servo-motor or gear coupled with the gripper belts 930 and 940 to be released from active driving and allow the gripper belts 930 and 940 to move freely with the motion of the FOUP 170. Once the gripper belts 930 and 940 fully engage the FOUP 170, the gripper system 910 may lift the FOUP 170 and remove the FOUP 170 from the original transport belts 110 and 120. Once lifted from the transport belts 110 and 120, the gripper system 910 may stop and/or move the FOUP 170 to an alternative location such as a buffer, transport rail, or process equipment load port.

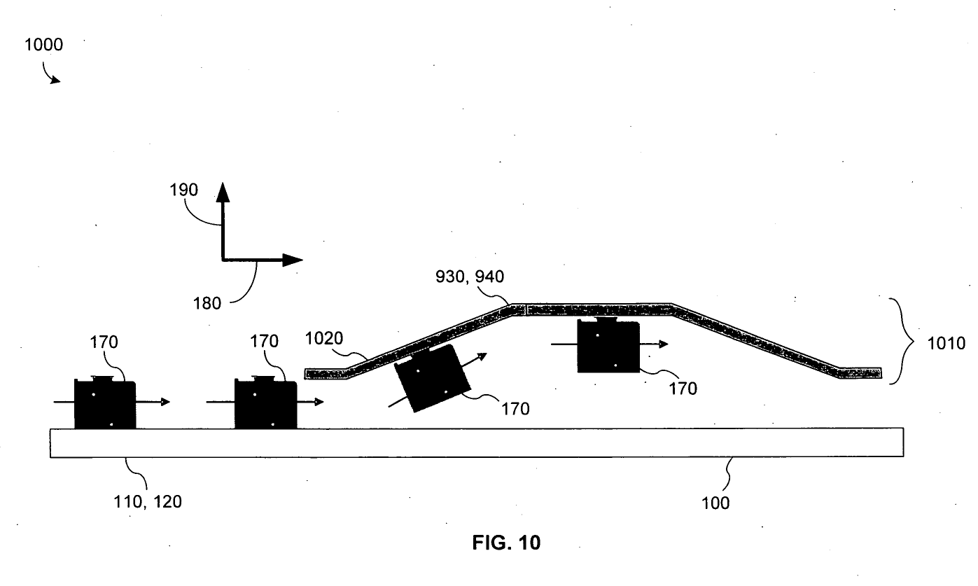

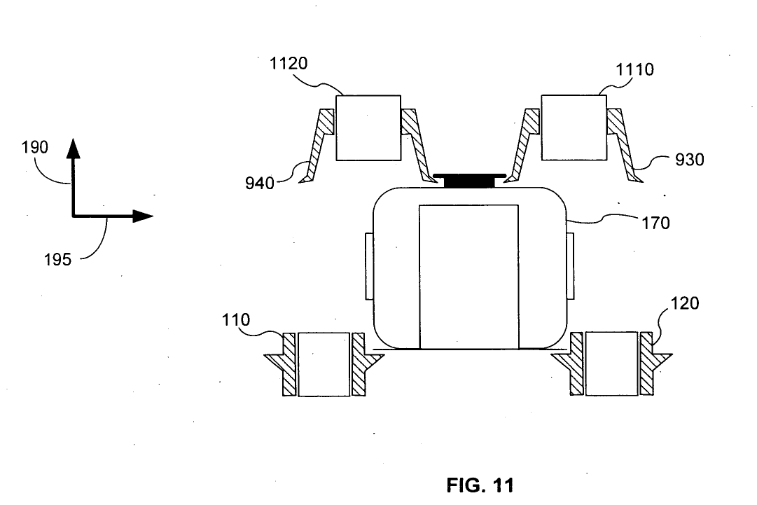

FIG. 10 illustrates a transport system 1000 comprising an overhead ramped gripper 1010 in conjunction with a conveyance section 100, according to various embodiments of the invention. In some embodiments, the gripper belts 930 and 940, as illustrated in FIG. 10, are constructed with a ramp feature. In these embodiments, the overhead ramped gripper 1010 grasps the FOUP 170 and lifts the FOUP 170 from the surface of the transport belts 110 and 120 using the gripper belts 930 and 940, and then moves the FOUP 170 upwards along a gripper belt ramp 1020. The overhead ramped gripper system 1010 is configured such that a conveyance path of the gripper belts 930 and 940 follows a shape of the gripper ramp 1020 without separate mechanism to move the gripper belts 930 and 940. Once the ramped gripper system 1010 moves the FOUP 170 above the transport belts 110 and 120, the ramped gripper system 1010 may stop movement of the FOUP 170 and hold the FOUP 170 in buffer as needed. Alternatively, the ramped gripper belt system 1010 may be curved rather than piece-wise linear as illustrated in FIG. 10. In other embodiments, the ramped gripper belt system 1010 may be curved in a horizontal axis 195 out of vertical alignment with the conveyance section 100. In still other embodiments, the ramped gripper belt system 1010 may be moved along a combination of a vertical axis 190, a horizontal axis 195, and/or a conveyance direction axis 180 using external motors to move the FOUP 170 and lower the FOUP 170 onto a different location, such as a different set of transport belts 110 and 120.

FIG. 11 illustrates a profile view of the gripper belts 930 and 940, according to various embodiments of the invention. In these embodiments, the gripper belts 930 and 940 are moved around pulleys 1110 and 1120, respectively, to match a speed of transport belts 110 and 120 as they transport the FOUP 170 along a conveyance direction 180.

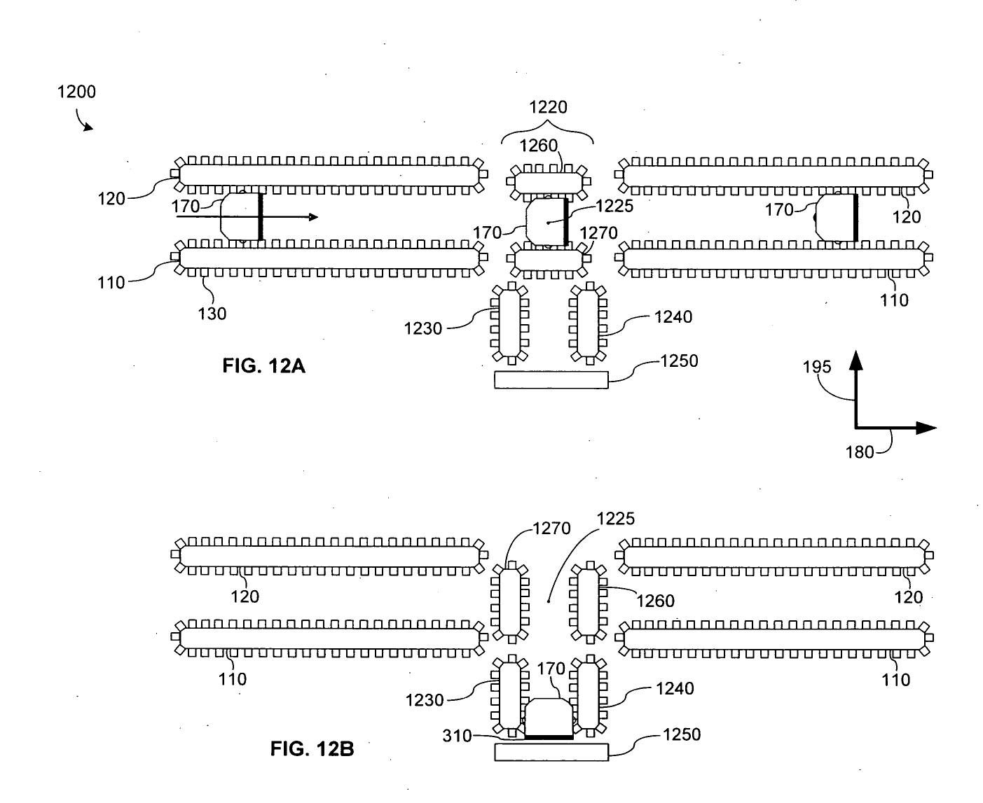

FIGS. 12A and 12B illustrate a transport system 1200 comprising several conveyance sections 100 and a turntable 1220, according to various embodiments of the invention. When transport belts such as transport belts 110 and 120 transport the FOUP 170, the FOUP 170 may be removed from the transport belts 110 and 120 to be placed on an equipment load port 1250. In some embodiments, the FOUP 170 is engaged to a load port 1250 specially configured to have a low complexity mechanism with a small delay in operations involving the FOUP 170. As illustrated in FIG. 12A, the transport belts 110 and 120 convey the FOUP 170 along a conveyance direction 180 toward a turntable 1220. The FOUP 170 is conveyed onto the turntable 1220. The turntable belts 1260 and 1270 may be configured to be stationary when the turntable 1220 rotates. Alternatively, the turntable belts 1260 and 1270 may be configured to move as the turntable 1220 rotates. The turntable belts 1260 and 1270 may be configured to match a speed of the transport belts 110 and 120 when the transport belts 110 and 120 convey the FOUP 170 onto the turntable belts 1260 and 1270. The turntable 1220 is configured to rotate about a central axis of rotation 1225 (perpendicular to the plane of the drawing) to change the direction of travel of the FOUP 170. The turntable belts 1260 and 1270 may be configured to significantly slow or stop motion of the FOUP 170 while the turntable 1220 rotates to change the direction of travel of the FOUP 170.

The turntable 1220 may rotate the FOUP 170 by, for example, approximately ninety degrees, to orient the turntable belts 1260 and 1270 such that the turntable belts 1260 and 1270 are in approximate alignment with destination transport belts such as the transport belts 1230 and 1240. Using the turntable belts 1260 and 1270, the turntable 1220 can move the FOUP 170 onto the transport belts 1230 and 1240. The transport belts 1230 and 1240 are configured to guide the FOUP 170 from the turntable 1220 directly to a specially configured load port 1250 of a process or metrology equipment or wafer sorting device, as illustrated in FIG. 12B. The load port 1250 may be configured to utilize a kinematic interface to clamp the FOUP 170 in place between the transport belts 1230 and 1240 from below. By clamping the FOUP 170 in place, the FOUP 170 may not move during processing. In various embodiments, the FOUP door 310 is pressed against the load port 1250 of the equipment such that the load port 1250 can open or remove the FOUP door 310 and the equipment can access the materials such as semiconductor wafers stored within the FOUP 170.

Once the process, metrology or sorting equipment has completed its task using the materials stored within the FOUP 170, the FOUP door 310 can be closed or replaced. The load port 1250 may now release the latch holding the FOUP 170 in place if needed. The transport belts 1230 and 1240 may thereafter move the FOUP 170 backwards to the turntable 1220. The turntable 1220 may then rotate the FOUP 170 to orient the FOUP 170 to travel on a selected pair of transport belts 110 and 120 to a next destination. Typically, the transport system 1200 is mounted at approximately the industry standardized load port height of 900 mm, or alternatively additional load ports 1250 may be provided on the process, metrology, or sorting equipment at a height of the installed transport belts 1230 and 1240. In some embodiments, the transport belts 1230 and 1240 may be ramped to move the FOUP 170 from a height of the turntable 1220 to a height of the equipment load port 1250.

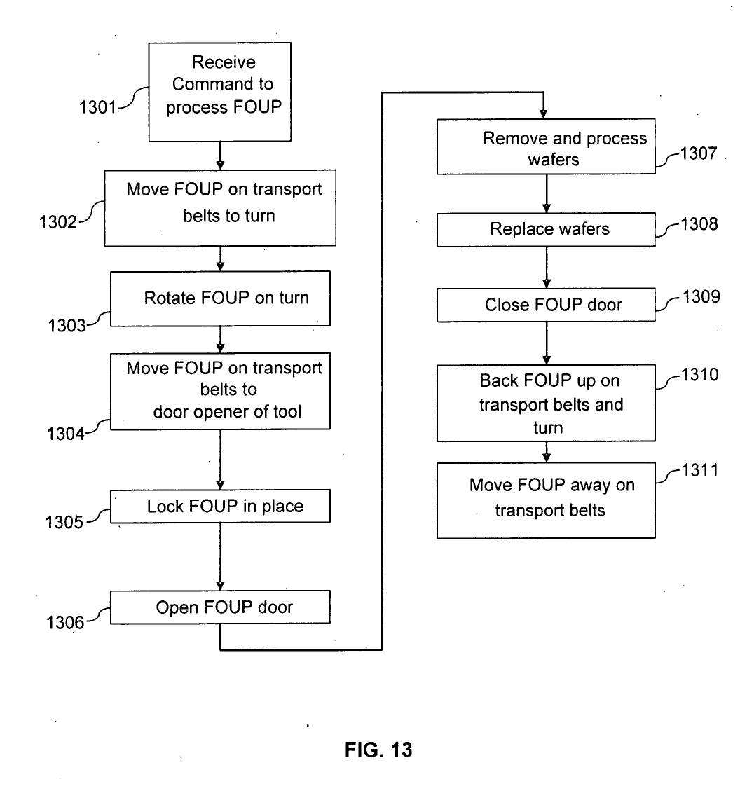

FIG. 13 illustrates a method of using the transport system 1200 illustrated in FIGS. 12A and 12B to transfer a FOUP 170 to and from a machine load port, according to various embodiments of the invention. The method may be implemented using a combination of computer systems comprising both hardware and software coupled with the transport system 1200 over a communications transmission path.

In step 1301, a command to process wafers within the FOUP 170 is received. The command may be first determined and transmitted by a computer system and/or operator configured to control the movement of FOUPs 170 throughout a transport system comprising a plurality of transport systems 1200, conveyance sections 200, and other related transport devices.

In step 1302, the transport belts 110 and 120 move the FOUP 170 onto the turntable belts 1260 and 1270 disposed on the turntable 1220.

In step 1303, the turntable 1220 rotates the FOUP 170 to align the turntable belts 1260 and 1270 with the transport belts 1230 and 1240. In some embodiments, the turntable belts 1260 and 1270 may be significantly slowed or stopped while the turntable 1220 rotates.

In step 1304, the turntable belts 1260 and 1270 move the FOUP 170 onto the transport belts 1230 and 1240. The transport belts 1230 and 1240 then move the FOUP 170 to the equipment load port 1250.

In step 1305, a mechanism coupled with the equipment load port 1250 optionally locks the FOUP 170 in place relative to equipment load port 1250. The mechanism may employ a three point kinematic interface to couple with the FOUP 170.

In step 1306, the mechanism coupled with the equipment load port 1250 opens or removes the FOUP door 310.

In step 1307, the equipment load port 1250 removes material such as semiconductor wafers from within the FOUP 170 for processing, measuring, or sorting by equipment attached to the equipment load port 1250.

In step 1308, the equipment load port 1250 replaces material such as semiconductor wafers to the FOUP 170 after processing, measuring, or sorting by equipment attached to the equipment load port 1250.

In step 1309, the mechanism coupled with the equipment load port 1250 replaces or closes the FOUP door 310.

In step 1310, the mechanism coupled with the equipment load port 1250 optionally unlocks the FOUP 170 in place relative to equipment load port 1250. The transport belts 1230 and 1240 then move the FOUP 170 from the equipment load port 1250 onto the turntable belts 1260 and 1270. The turntable 1220 then rotates the FOUP 170 to approximately align the turntable belts 1260 and 1270 with the transport belts 110 and 120.

In step 1311, the transport belts 110 and 120 transport the FOUP 170 along a conveyance direction to another location.

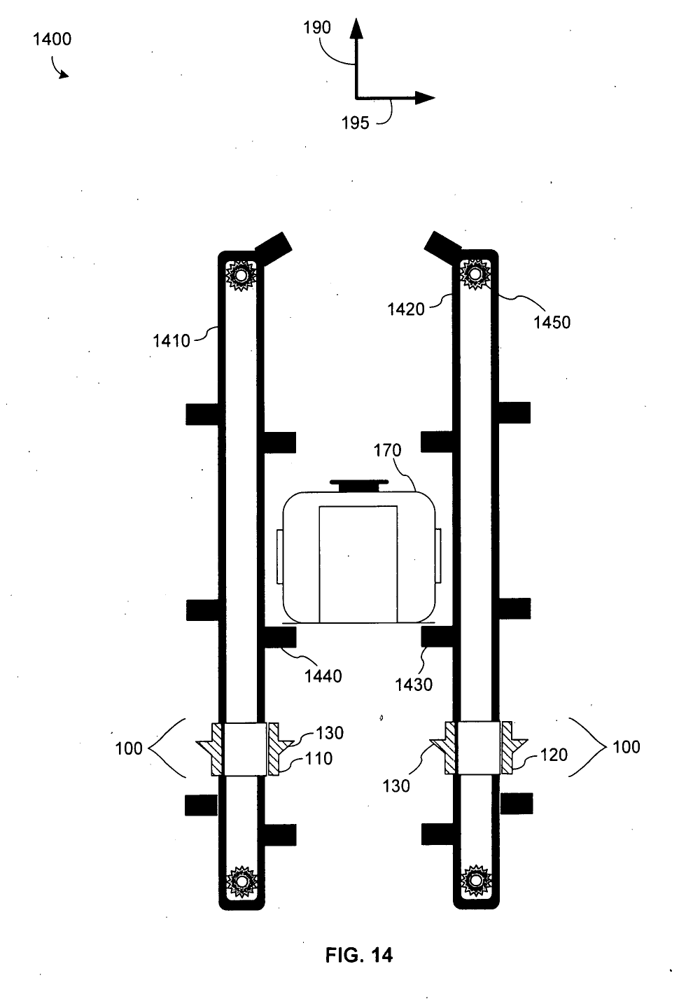

FIG. 14 illustrates a vertical conveyance section or elevator 1400, according to various embodiments of the invention. The elevator 1400 may be configured to move the FOUP 170 along a vertical axis 190 from one horizontal plane to another horizontal plane to change the elevation of the FOUP 170. The elevator 1400 may be useful, for example, to move the FOUP 170 from one location at a first horizontal plane, such as a first conveyance section 100, to another location at a second horizontal plane, such as second conveyance section 100. In some embodiments, as illustrated in FIG. 14, the elevator 1400 raises or lowers the FOUP 170 along a vertical axis 190 as transport belts 110 and 120 transport the FOUP 170 along a horizontal conveyance direction 180. A horizontally aligned segment of the transport belts 110 and 120 may be placed on the elevator 1400 such that the FOUP 170 may be disposed on the transport belts 110 and 120 while the horizontally aligned segment is moved up or down along a vertical axis 190 to a desired elevation. The horizontally aligned segment of the transport belts 110 and 120 may then move the FOUP 170 off of the horizontally aligned segment to another location.

As illustrated in FIG. 14, elevator belts 1410 and 1420 may be placed in alignment with and perpendicular to the transport belts 110 and 120. A pair of elevator supports 1430 and 1440 are attached to the elevator belts 1410 and 1420 and configured to be positioned below the level of the FOUP 170. The elevator belts 1410 and 1420 are configured to raise the elevator supports 1430 and 1440 along the vertical axis 190 such that the elevator supports 1430 and 1440 lift the FOUP 170 up from the transport belts 110 and 120 to a new level. At the new level, another transport mechanism such as a conveyance section 100, lift 210, gripper 810, overhead gripper belts 910, or the like may be configured to move the FOUP 170 to another location.

In various embodiments, the elevator 1400 is configured to rotate the FOUP 170 about an axis such that the elevator moves the FOUP 170 to a location at a different elevation and along a different horizontal conveyance direction than the conveyance direction 180 from which the elevator 1400 receives the FOUP 170. The elevator 1400 may be configured to rotate by an angle of approximately 90 degrees, 180 degrees, 270 degrees, or other arbitrary angles between zero degrees and 180 degrees.

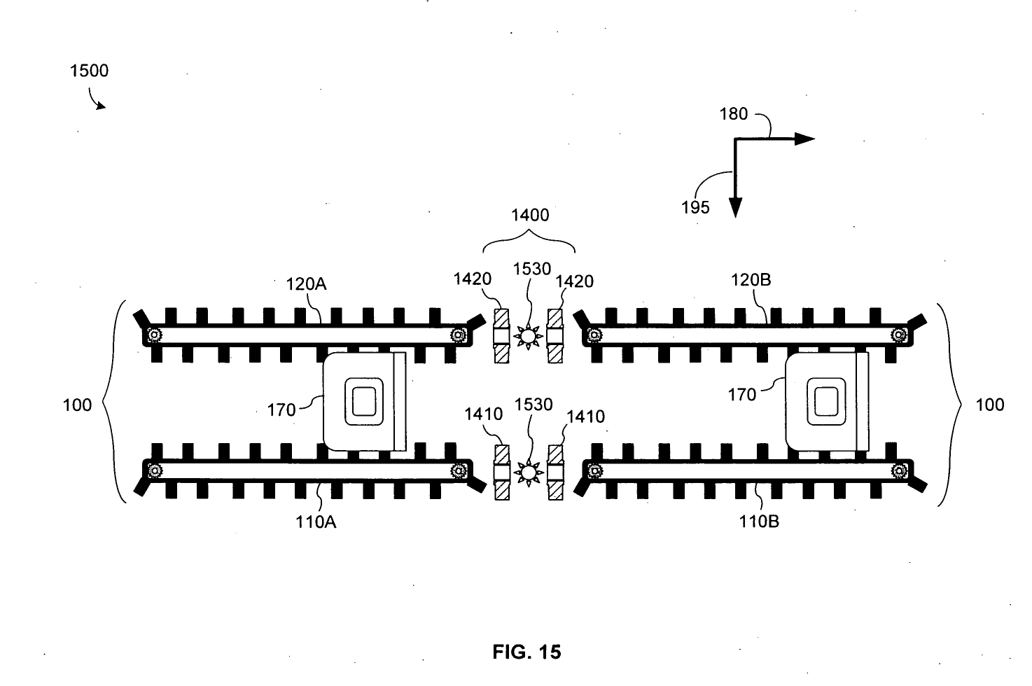

FIG. 15 illustrates a transport system 1500 comprising several conveyance sections 100 and an elevator 1400 as illustrated in FIG. 14. The transport belts 110A and 120A at one horizontal plane are configured to transport the FOUP 170 to the elevator 1400. The rollers 1530 may also be configured to guide the FOUP 170 onto the elevator belts 1410 and 1420 in conjunction with the transport belts 110A and 120A. After the FOUP 170 is transferred from the transport belts 110A and 120A to the elevator belts 1410 and 1420, the elevator 1400 is configured to lower or raise the FOUP 170 along a vertical axis 190 (perpendicular to the plane of the drawing) to a destination height of the transport belts 110B and 120B. After the FOUP 170 reaches the destination height of the transport belts 110B and 120B, the roller 1530 or additional transport belts 110 and 120 may be configured to move the FOUP 170 off the elevator belts 1410 and 1420 onto another set of transport belts 110B and 120B at the new height.

The rollers 1530 or transport belts 110 and 120 may be configured to move laterally along the horizontal axis 195 such that they provide greater clearance between them and the FOUP 170 when the elevator 1400 raises or lowers the FOUP 170 along the vertical axis 190. Alternatively, the rollers 1530 or transport belts 110 and 120 may be rotated out of the way to provide greater clearance for the FOUP 170 as illustrated in FIG. 7.

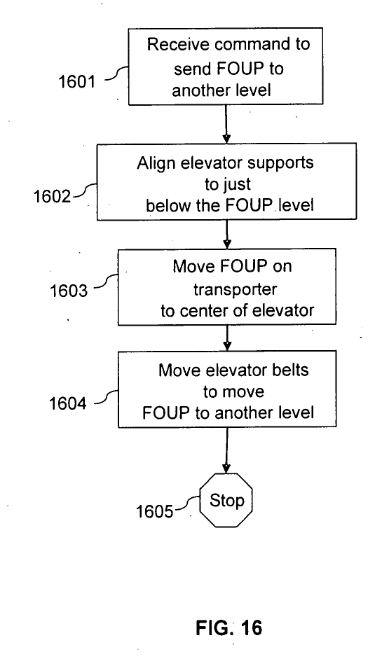

FIG. 16 illustrates a method of transferring a FOUP in a vertical direction 190 using the elevator 1400 as illustrated in FIGS. 14 and 15. The method may be implemented using a combination of computer systems comprising both hardware and software coupled with the elevator 1400.

In step 1601, a command to move the FOUP 170 to another level is received. The command may be first determined and transmitted by a computer system and/or operator configured to control the movement of FOUPs 170 throughout a transport system comprising a plurality of elevators 1400, conveyance sections 100, and other related transport devices over a communications transmission path.

In step 1602, the elevator supports 1430 are positioned just below a vertical level of the FOUP 170.

In step 1603, the FOUP 170 is moved to the center of the elevator, for example by transport belts 110 and 120 and/or rollers 1530.

In step 1604, the FOUP 170 is moved to another level along the vertical axis 190 using the elevator 1400.

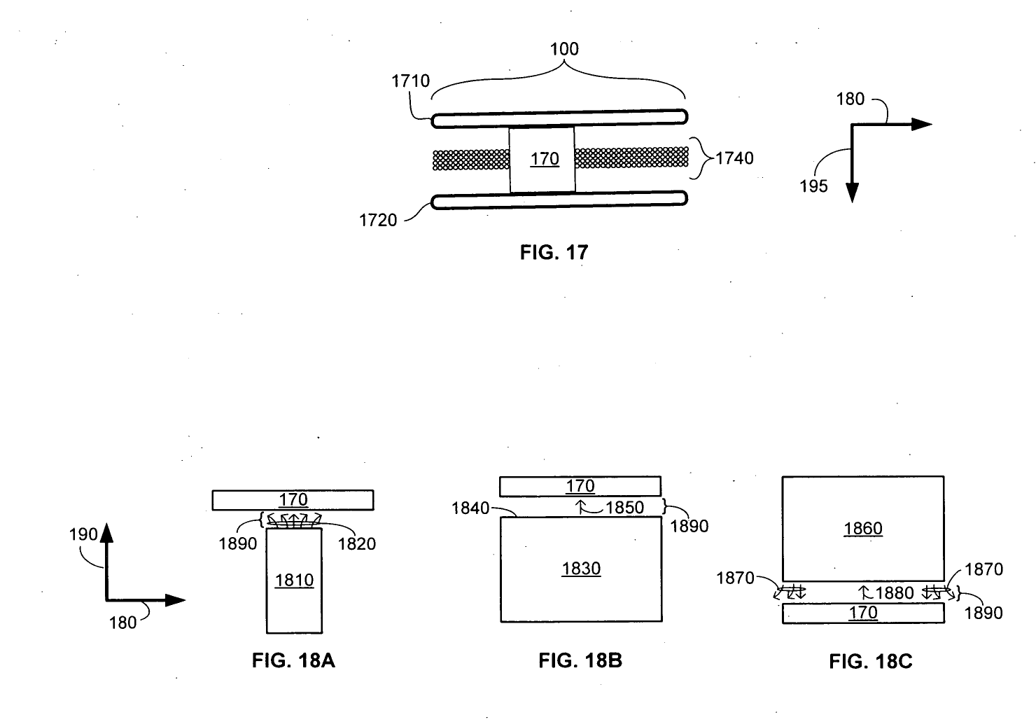

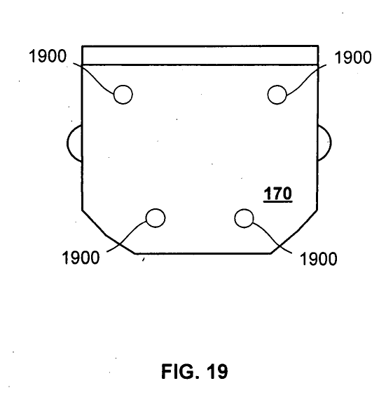

FIG. 17 illustrates a transport section 100 comprising a first transport belt 110 and a second transport belt 120, the transport section 100 being configured to provide air bearings along a conveyance path between the first transport belt 110 and the second transport belt 120. The one or more air bearings are provided to additionally support an article while the first transport belt 110 and the second transport belt 120 guide the article in a conveyance direction 180. As illustrated in FIG. 17, region 1740 represents a location where such air bearings can be provided, either below or above the article. Exemplary air bearing generators for providing air bearings within region 1740 are described with respect to FIGS. 18A-18C. In various embodiments, the first transport belt 110 and the second transport belt 120 are vertical belts, horizontal belts, slanted belts that are oriented in a direction between vertical and horizontal, or combinations thereof. In some embodiments, at least some portion of the first transport belt 110 and/or the second transport belt 120 are substituted with rollers such as vertical rollers or horizontal rollers.

In some embodiments, one or more air bearings are disposed between adjacent conveyance sections 100. In these embodiments, the air bearings are typically configured to support an article as the article is transported between a first conveyance section 100 and an adjacent conveyance section 100 along a conveyance direction 180.

An air bearing may serve as an air-cushion non-contact supporting system, as described in U.S. Patent Application Publication 2006/0054774 entitled “High-Performance Non-Contact Support Platforms” which is incorporated herein by reference. In some embodiments, a plurality of air bearings are provided proximate to one another and approximately in a line parallel to the conveyance direction 180 along the conveyance path. In other embodiments, a plurality of air bearings are provided proximate to one another and approximately in a line perpendicular to the conveyance direction 180 along the conveyance path. In still other embodiments, a plurality of air bearings are provided proximate to one another in two dimensional groupings. In additional embodiments, one or more air bearings are provided in irregular locations and patterns between transport belt 110 and transport belt 120.

In some embodiments, the air bearings are configured to additionally support the article in a central region of the article between edges of the article that are supported by the transport belt 110 and the transport 120. In various embodiments, the article comprises a substrate including glass, polymer, or semiconductor material. The article may also comprise substrates for the manufacture of liquid crystal, organic light emitting diode or other types of display devices, a memory substrate (such as a hard drive platter substrate or an optical storage device substrate), a photovoltaic device substrate, a battery substrate, or the like. By supporting the central region of the article, the air bearings may reduce stress on the article, and prevent damage or breakage due to bending caused by uneven support across the width of the article between the transport belt 110 and the transport belt 120. In some embodiments, the air bearings may support an article such as a substrate characterized by an area less than 1 square meter, between 1 square meter and 5 square meters, between 5 square meters and 6 square meters, or between 6 square meters and 7 square meters.

The air bearings may also reduce physical contact between the conveyance section 100 and the article in comparison with alternative support members such as rollers, consequently reducing friction and vibration. Reduced contact and friction may also reduce contamination of the article and the ambient environment, for example by minimizing scrubbing of material contacting the article during transport.

FIGS. 18A, 18B, and 18C illustrate air bearing generators configured to generate the air bearings illustrated in FIG. 17. FIG. 18A illustrates various embodiments of an air bearing generator 1810. In these embodiments, the air bearing generator 1810 may be configured to generate an air bearing 1890 by generating an upward air stream 1820. The upward air stream 1820 forms the air bearing 1890 by providing physical support to the article when the article travels above the air bearing 1890 along the conveyance path. The air bearing generator 1810 may be configured to emit one or more air streams 1820 emanating from one or more holes in a tube or support member. A velocity and quantity of air within the one or more air streams 1820 determines a level of support provided by the one or more air streams 1820 to the article, such as a substrate.

The air bearing generator 1810 may optionally be configured to output a significantly reduced air stream 1820 or no air stream 1820 when the article is not in a path of the air stream 1820. For example, the air bearing generator 1810 may be configured to only output the air stream 1820 directly upward if the article is above the air bearing 1890, and to output a reduced air stream 1820 when there is no article above the air bearing 1890. In some embodiments, turbulent limited orifices, such as those described in U.S. Pat. No. 6,523,572 entitled “Apparatus for Inducing Forces by Fluid Injection” which is incorporated herein by reference, may be used to limit the air stream 1820 when there is no article above the air bearing 1890.

FIG. 18B illustrates an alternative embodiment of an air bearing generator 1830 utilizing ultrasonic levitation. U.S. Pat. No. 5,810,155 entitled “Object Levitating Apparatus Object Transporting Apparatus and Object Levitating Bearing Along with an Object Levitating Process and Object Transporting Process,” which is incorporated herein by reference, discloses various embodiments of an object levitating apparatus using ultrasonic excitation. Ultrasonic levitation may typically be used to levitate an article, which may be characterized by thicknesses of approximately 1 mm to 2 mm, above a support surface 1840. Ultrasonic levitation uses ultrasonic waves generated between the support surface 1840 and the article to drive airflow into a space between the article and the support surface 1840, and to inhibit air from flowing out of the space between the article and the support surface 1840. In this way, the air bearing generator 1830 creates an air pressure differential between the article and the support surface 1840 compared to the ambient air pressure around the article. The air pressure differential creates an upward force 1850 that forms an air bearing 1890 that in turn levitates the article above the support surface 1840.

FIG. 18C illustrates alternative embodiments of an air bearing generator 1860 utilizing a Venturi vacuum support system. A Venturi vacuum support system supports an article such as a substrate from above rather than from underneath. As an air stream 1870 emanates downward through a Venturi nozzle disposed in the air bearing generator 1860, a vortex or Venturi is created in the center of the Venturi nozzle. The center of the Venturi or vortex is characterized by a lower air pressure than the ambient air pressure, thereby creating a localized vacuum and a suction force 1880 tending to lift the article upward toward the center of the Venturi nozzle. The air stream 1870 which escapes below the Venturi nozzle in the air bearing generator 1870 forms an air bearing 1890. The air bearing 1890 creates an equilibrium between the upward suction force 1880 and a downward force caused by the air stream 1870 emanating from the Venturi nozzle within the air bearing generator 1860.

Several embodiments are specifically illustrated and/or described herein. However, it will be appreciated that modifications and variations are covered by the above teachings and within the scope of the appended claims without departing from the spirit and intended scope thereof. For example, while the transportation of FOUPs in semiconductor manufacturing have been used herein as an illustrative example, systems and methods of the invention may be configured for transporting alternative materials, such as for example, substrates for the manufacture of liquid crystal, organic light emitting diode or other types of display devices, a memory substrate (such as a hard drive platter substrate or an optical storage device substrate), a photovoltaic device substrate, a battery substrate, or the like. Further, the vertical rollers and vertical belts discussed herein need not be perfectly vertical. The spacing of vertical rollers as illustrated herein is for illustrative purposes only. In various embodiments, vertical rollers may be disposed in a wide variety of spacings, from closely packed to widely dispersed including a single roller or rollers located only at each end of a belt. In various embodiments, horizontal rollers may be disposed in place of vertical rollers, and horizontal belts may be disposed in place of vertical belts.

In various embodiments, various disclosed elements such as transfer devices and conveyance sections may be disposed in conjunction with, coupled with, and/or integrated with various other disclosed elements so as to configure a system comprising multiple disclosed elements to transport an article from one location to another location. For example, an elevator may be integrated with an equipment load port or a turntable. Support elements such as transition wheels and air bearings may be disposed in any appropriate location throughout a conveyance section or transfer system as appropriate to support and/or guide articles being conveyed through the conveyance section or transfer system. Attributes disclosed with respect to one disclosed element, such as a conveyance section or a transport belt, may be applicable to another disclosed element, such as a gripper belt or an elevator.

In further embodiments of the lift 210, the lift 210 can be additionally configured to purge the interior of the FOUP 170. This would allow the FOUP 170 to be purged with a gas such as clean dry air, or nitrogen, while the FOUP 170 is engaged with the lift 210. To accomplish the purge, the lift 210 can include one or more needle valves that are positioned to interface with the FOUP valves 1900 shown in the bottom view of the FOUP 170 in FIG. 19. For example, two such needle valves can be used to inject the gas and two can be used to allow the FOUP 170 to vent.

In various embodiments, each of the various belts discussed herein may be replaced by two or more belts. Likewise, each of the various belts discussed herein may be replaced by a combination of belt(s) and guide wheel(s), the guide wheels configured to support a FOUP directly without use of a belt between the guide wheel and the FOUP. In various embodiments, any one or more of the belts discussed herein are each supported by more than two guide wheels.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

What is claimed is:

1. A system comprising:
a first conveyance section comprising a first transport belt and a second transport belt disposed on either side of a conveyance path, the first conveyance section configured to convey a FOUP along the conveyance path, the first transport belt and the second transport belt separated by a distance configured for placement of the FOUP between the first transport belt and the second transport belt;
a lift configured to lift the FOUP from the first transport belt and the second transport belt, the lift further configured to rotate the FOUP such that the FOUP can pass between the first transport belt and the second transport belt along a vertical axis.

2. The system of claim 1, wherein the FOUP includes semiconductor wafers.

3. The system of claim 1, wherein the lift is configured to move the FOUP from the first conveyance section to a second conveyance section, the second conveyance section being at a different angle relative to the first conveyance section.

4. The system of claim 1, wherein the lift is configured to move the FOUP from the first conveyance section to a second conveyance section, the second conveyance section being at a different height relative to the first conveyance section.

5. The system of claim 4 wherein the first conveyance section is configured to move the first transport belt and the second transport belt away from each other in a direction perpendicular to a direction of the conveyance path such that distance separating the first transport belt and the second transport belt is increased to allow the FOUP to pass between the first transport belt and the second transport belt along the vertical axis.

6. The system of claim 1, wherein the lift includes a kinematic interface configured to couple with the FOUP.

7. A system comprising:
a first conveyance section comprising a first transport belt and a second transport belt disposed on either side of a conveyance path, the first conveyance section configured to convey a FOUP along the conveyance path, the first transport belt and the second transport belt separated by a distance configured for placement of the FOUP between the first transport belt and the second transport belt, the first conveyance section being disposed at a first height; and
an elevator comprising a first elevator belt and a second elevator belt, the elevator configured to lift the FOUP from the first conveyance section, the elevator further configured move the FOUP to a second conveyance section at a second height.

8. The system of claim 7 wherein first conveyance section and the elevator share a communications transmission path.

9. The system of claim 7 wherein the elevator is further configured to move the FOUP to an equipment load port.

10. The system of claim 7 wherein the system is configured to use a kinematic interface to interface with the FOUP.

11. A system comprising:
a first conveyance section comprising a first transport belt and a second transport belt disposed on either side of a conveyance path, the first conveyance section configured to convey a FOUP along the conveyance path, the first transport belt and the second transport belt separated by a distance configured for placement of the FOUP between the first transport belt and the second transport belt, the first conveyance section being disposed at a first height; and
an overhead gripper comprising a first gripper belt and a second gripper belt, the first gripper belt and the second gripper belt being configured to grip a top handle of the FOUP, the overhead gripper being further configured to raise the FOUP from the first height to a second height.

12. The system of claim 11, wherein the FOUP is moved from the first conveyance section to a second conveyance section at the second height.

13. The system of claim 11 further comprising an elevator configured to move the FOUP from a second height to a third height.

14. The system of claim 11 wherein the overhead gripper is configured to move in synchronization with the FOUP and grasp a top handle of the FOUP while the FOUP is in motion.

15. The system of claim 11 wherein the first gripper belt and the second gripper belt are not powered.

16. The system of claim 11 wherein the overhead gripper is configured to deliver the FOUP with a front door directly to the door opener at an equipment load port.

17. A system comprising:
a first belt and a second belt disposed on either side of a conveyance path and configured to convey an article along the conveyance path, the first belt and the second belt separated by a distance configured for placement of the article between the first belt and the second belt;
a plurality of approximately vertical rollers configured to guide the first belt and the second belt;
a plurality of support protrusions extending from each of the first belt and the second belt, the plurality of support protrusions configured to support the article; and
an air bearing generator disposed between the first and second belts and configured to provide an air bearing capable of further supporting the article.

18. The system of claim 17 wherein the air bearing generator is configured to emit an air stream towards the article from beneath the article.

19. The system of claim 18 wherein the air bearing generator includes a turbulent limited orifice.

20. The system of claim 17 wherein the air bearing generator is configured to further support the article through ultrasonic levitation.

21. The system of claim 17 wherein the air bearing generator comprises a Venturi nozzle.

22. The system of claim 1 wherein the lift is further configured to purge the interior of the FOUP while the lift and the FOUP are engaged.
